(19) United States
(12) Patent Application Publication
(10) Pub. No.: US 2011/0079411 A1
(43) Pub. Date: Apr. 7, 2011

(54) INSULATING SPACER FOR GAS-INSULATED ELECTRICAL EQUIPMENT

(75) Inventors: Ryoichi Shinohara, Hitachi (JP); Tatsurou Kato, Hitachi (JP); Toshiaki Rokunohe, Hitachi (JP)

(73) Assignee: JAPAN AE POWER SYSTEMS CORPORATION, Tokyo (JP)

(21) Appl. No.: 12/996,090

(22) PCT Filed: May 25, 2009
(86) PCT No.: PCT/JP2009/059930

§ 371 Date: Dec. 3, 2010

(30) Foreign Application Priority Data
Jun. 5, 2008 (JP) 2008-147649

(51) Int. Cl. H01B 17/16

(52) U.S. Cl. 174/30

(57) ABSTRACT

An insulating spacer 10 includes a molded insulator 11 having a central conductor 12. The molded insulator 11 part is disposed between the flanges 1A, 2A of metal containers 1, 2 and is coupled by through bolts 5. The peripheral dimension of the molded insulator 11 is smaller than the flanges 1A, 2A, and the insulating spacer 10 is provided with a thin section 11A, one lateral side of which is formed into a thin ring shape. A ring-shaped metal fitting 14 having a cross-sectional L-shape is fitted onto the thin section 11A of the molded insulator 11, the ring-shaped metal fitting 14 defining the dimensions of the space between the flanges 1A, 2A and forming a current path between the metal containers 1, 2. The ring-shaped metal fitting 14 is affixed to the thin section 11A of the molded insulator 11 by multiple tightening bolts 15.

### TECHNICAL FIELD

The present invention relates to an insulating spacer for gas-insulated electrical equipment particularly to such an insulating spacer for gas-insulated electrical equipment as is to be arranged at a junction between metal containers.

### BACKGROUND ART

As a general practice in a gas-insulated electrical equipment such as a gas-insulated switchgear (hereinafter referred to as “GIS”), grounded cylindrical metal containers are joined at their flanges interposing an insulating spacer therebetween to provide gas-sections and an insulating gas, such as SF6, is filled inside each of the meal containers at a pressure of 0.4 to 0.6 MPa.

GIS includes various constituent devices that are accommodated within the metal containers such as breakers, disconnectors, grounding switches, and bus conductors. Among these devices, gas-sections sealed with insulating spacers are formed to establish properly spaced gas-sections considering operation and treatment time of the insulating gas.

Usually, an insulating spacer should satisfy required insulation performance and should have a proper mechanical strength enough for sealing a high-pressure gas hermetically. To respond to this demand, the insulating spacer mainly uses alumina-filled epoxy resin or silica-filled epoxy resin. Further, the insulating spacer is used in a variety of shapes such as so-called a conical spacer, which has a concavo-convex shape, i.e., one side of which is convex and the other side concave so that the intensity of the electrical field along the surface of the insulating spacer will be weakened while reducing radial dimension; or so called a disc spacer that has no concavo-convex shape.

For example, JP 03-124210 A1 (Patent Literature 1) has described an insulating spacer of conical spacer type that is arranged between metal flanges of metal containers joining them. The insulating spacer supports a high voltage conductor at the center of its spacer body of a molded insulator and has a ring-shaped metal material flange on the outer circumference thereof. Where the insulating spacer is arranged between the flanges of the metal containers and is secured with tightening through bolts joining the flanges of the metal container, the ring-shaped metal material flange bears the tightening force that appears in joining the flanges of the metal containers to prevent the molded insulator from occurrence of breakage. The molded insulator is secured between the flanges of the metal containers being sandwiched by the ring-shaped metal material and a pressing-pad.

Further for example, JP 2007-14070 A1 (Patent Literature 2) has described an insulating spacer of disc spacer type. The insulating spacer defined in Patent Literature 2 has such a construction as has a center conductor embedded in its center and a plurality of embedded metal fittings on the circumference of the periphery. thereof. The insulating spacer is secured on a metal circular flange with bolts using the embedded metal fittings and only the circular flange portion is arranged between the flanges of metal containers to be fastened with tightening through bolts joining the flanges of the metal containers.

In the insulating spacer of Patent Literature 1 stated above, the ring-shaped metal material flange can be made bear the tightening force that appears in joining the flanges of the metal containers between which the insulating spacer is arranged and secured with tightening through bolts. However, because this configuration is to hold the molded insulator by sandwiching it between the ring-shaped metal material and the pressing-pad, inequality in tightening forces among plural tightening through bolts or the excessive tightening of the tightening through bolts beyond the specified torque may cause breakage in the molded insulator.

If breakage occurs in the molded insulator of the insulting spacer, the gas filled inside the metal container of the electrical equipment leaks developing finally into an insulation breakdown accident, or else in an extreme case, a rapid belching out of the insulating gas will cause an explosion accident; any of these will lower the reliability of the gas-insulated electrical equipment. To avoid this, it is necessary to contrive such as increasing the thickness of the molded insulator, which is a prime constituent of the insulating spacer, for increased strength, and further, re-arranging the location of the ring-shaped metal material and the pressing-pad. However, these have encountered problems in that the manufacturing of the insulating spacer will become costly.

The insulating spacer of Patent Literature 2 stated above is such a device as is to be secured on the metal circular flange with bolts. This configuration requires that the metal container should be enlarged to the extent compatible with the increment of dimension attributable to the circular flange to maintain the reliability of the gas-insulated electrical equipment. Therefore, there has been a problem in that the manufacturing of the insulating spacer will become costly.

An object of the present invention is to provide an insulating spacer for gas-insulated electrical equipment, i.e., a spacer being highly reliable and capable of being economically manufactured, as well as having a simple structure.

### DISCLOSURE OF INVENTION

The present invention provides an insulating spacer for gas-insulated electrical equipment having such a construction that a molded insulator; a central conductor being embedded in the molded insulator; and a metal material being arranged at the peripheral dimension of the molded insulator, the metal material with the molded insulator being placed between flanges of metal containers, the flanges being coupled by a plurality of through bolts, in which the peripheral dimension of the molded insulator is smaller than the dimensions of the flanges, the molded insulator has a thin section, one lateral side of the thin section being molded into a thin ring shape, a ring-shaped metal fitting of a cross-sectional L-shape is fitted onto the thin section, the ring-shaped metal fitting defining the dimension between the flanges and forming a current carrying path between the metal containers, and the ring-shaped metal fitting and the thin section are secured by a plurality of tightening bolts.

It is preferable that the thin section of the molded insulator has a plurality of U-shaped notches for passing the through bolts therethrough.

It is also preferable that the tightening bolts are arranged on the flat portion of the inner side of the ring-shaped metal fitting at approximately regular intervals.

### EFFECT OF INVENTION

With the configuration of an insulating spacer for gas-insulated electrical equipment as defined by the present invention, the insulating spacer, which is provided through steps of manufacturing separately the molded insulator having a thin section and the ring-shaped metal fitting having a cross-sectional L-shape and affixing the ring-shaped metal fitting integrally to the thin section of the molded insulator using a plurality of tightening bolts, can be interposed between the flanges of the metal containers enabling the flanges being coupled by a plurality of through bolts. Thereby, it will be offered that a good gas-tightness of the gas-section of the metal container will be maintained at the molded insulator portion in the insulating spacer, that the current carrying path for the circulating current can be secured by a shared use of the ring-shaped metal fitting as a connecting conductor between the metal containers, and, accordingly, that a highly reliable insulating spacer can be economically manufactured.

### BRIEF DESCRIPTION OF DRAWINGS

FIG. 1 is a schematic vertical sectional view of an insulating spacer for gas-insulated electrical equipment as an embodiment of the present invention to illustrate its aspects of being fabricated-and-in-use state.

FIG. 2 is a schematic vertical sectional view of the insulating spacer for gas-insulated electrical equipment illustrated in FIG. 1 sectioned along a plane different from the one in FIG. 1 to illustrate its aspects of being fabricated-and-in-use state.

FIG. 3 is an enlarged exploded view of the edge portion of the insulating spacer for gas-insulated electrical equipment illustrated in FIG. 1.

FIG. 4 is a side view of the insulating spacer for gas-insulated electrical equipment illustrated in FIG. 1 to illustrate its aspects of being fabricated state.

FIG. 5 is a side view of the object illustrated in FIG. 2 to illustrate an exploded aspect thereof.

FIG. 6 is a perspective exploded view of the object illustrated in FIG. 2.

FIG. 7 is a side view of a three-phase type insulating spacer for gas-insulated electrical equipment to which the present invention is applied to illustrate its aspects of being fabricated state.

FIG. 8 is a schematic vertical sectional view of an insulating spacer for gas-insulated electrical equipment as another embodiment of the present invention to illustrate its aspects of being fabricated-and-in-use state.

FIG. 9 is a side view of the insulating spacer for gas-insulated electrical equipment illustrated in FIG. 8 to illustrate its aspects of being fabricated state.

### BEST MODE FOR CARRYING OUT INVENTION

The insulating spacer for gas-insulated electrical equipment by the present invention has a molded insulator having a central conductor embedded therein. The insulating spacer is interposed between flanges of metal containers with a metal material arranged on the peripheral dimension thereof and secured by a plurality of through bolts. The insulating spacer is given such a dimension that the peripheral dimension thereof is smaller than the dimensions of the flanges and is peripherally provided with a thin section, one lateral side of which is formed into a thin ring shape. On this thin section, a ring-shaped metal fitting having a cross-sectional L-shape, which defines the distance of spacing between the flanges and forms a current carrying path between the metal containers, is fitted; and the ring-shaped metal fitting is affixed to the thin section of the molded insulator by a plurality of tightening bolts.

### Embodiment 1

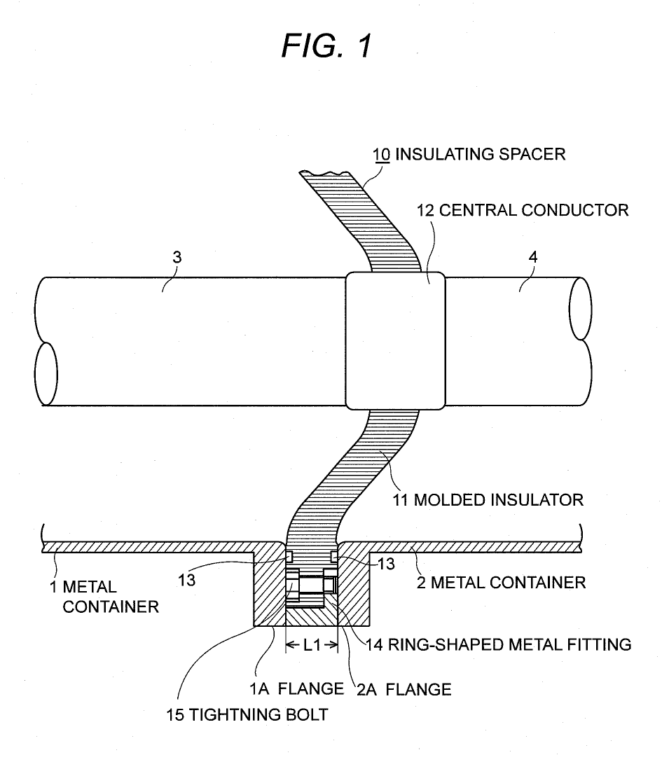

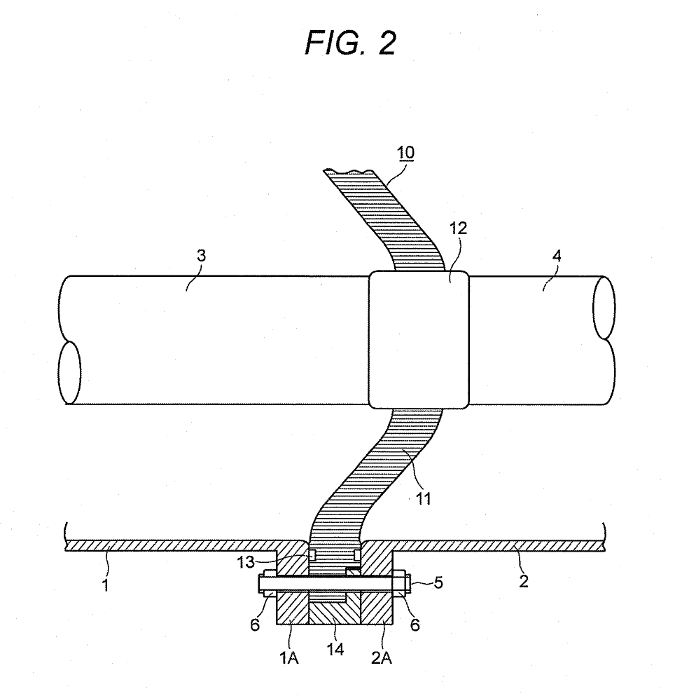

Hereunder, explanation of the insulating spacer for gas-insulated electrical equipment as an embodiment of the present invention will follow referring to FIGS. 1 to 6. In the embodiment illustrated in FIG. 1 and FIG. 2, an insulating spacer 10 to which the present invention is applied is interposed between flanges 1A and 2A respectively of metal containers 1 and 2, inside which high-voltage live conductors 3 and 4 are accommodated and insulating gas such as SF6 is filled, coupling them forming gas-sections.

The insulating spacer 10 has a molded insulator 11, a molding of thermosetting resin such as epoxy resin, and a center conductor 12 embedded therein, in which the center conductor 12 is connected with the live conductors 3 and 4. The flanges 1A and 2A of the metal containers 1 and 2, having the insulating spacer therebetween, are coupled by a plurality of through bolts 5, so-called stud bolts, and nuts 6 with specified tightening force.

The molded insulator 11, which is arranged so that the edge portion of its peripheral dimension will be sandwiched between the flange 1A and 2A, is secured by the through bolt 5 and nut 6. In this arrangement, an O-ring 13 is placed in a groove formed on the both sides of the molded insulator 11 or on the flanges 1A and 2A to maintain the gas-tightness at the insulating spacer 10.

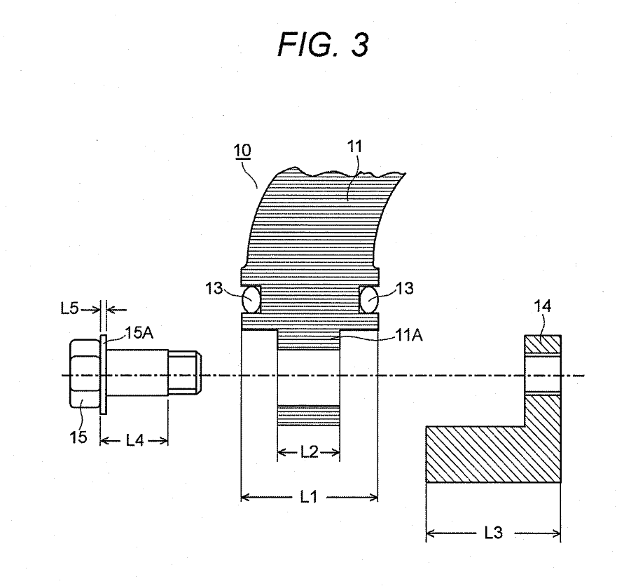

The molded insulator 11, which is a prime constituent of the insulating spacer 10, is given such a dimension that the edge portion of its peripheral dimension is smaller than the dimensions of the flanges 1A and 2A. Further, one lateral side (the right-side face thereof in FIG. 1 and FIG. 2) of the molded insulator 11 illustrated in FIG. 3 is thinned to provide a thin section 11A shaped in a ring. On this thin section 11A of the molded insulator 11, a ring-shaped metal fitting 14 having a cross-sectional L-shape is arranged so that the free end thereof will cover the edge portion of the peripheral dimension of the smaller-dimensioned molded insulator 11.

With this configuration, when the insulating spacer 10 is interposed between the flanges 1A and 2A of the metal containers 1 and 2 and secured by the through bolt 5 and the nut 6, the ring-shaped metal fitting 14 having cross-sectional L-shape fitted onto the thin section 11A defines the distance of spacing between the flanges 1A and 2A to prevent an excessive deformation of the O-ring 13 placed in the groove formed on the both sides of the insulating spacer 10 as illustrated in FIG. 1 and FIG. 2. Further, the ring-shaped metal fitting 14 is made from a current carrying path between the metal containers 1 and 2.

Screwing a tightening bolt 15 into the ring-shaped metal fitting 14 from the other side of the molded insulator 11 affixes the ring-shaped metal fitting 14 integrally on the thin section 11A of the molded insulator 11 as illustrated in FIG. 3. The ring-shaped metal fitting 14 having cross-sectional L-shape can be easily manufactured by, for example, machine-cutting applied to a metal plate having a specified thickness that will be mentioned later.

FIG. 3 indicates a dimensional relationship between the molded insulator 11 of the insulating spacer 10 and the ring-shaped metal fitting 14 having cross-sectional L-shape. When the thickness of the molded insulator 11 is denoted as the dimension L1, the thin section 11A is molded in a thickness denoted as the dimension L2 considering the location of the ring-shaped metal fitting 14 and the tightening bolt 15. If the tightening bolt 15 is excessively tightened, an improper pressing force will appear causing breakage on or residual stress in the molded insulator 11. The portion that bears residual stress may develop to a trigger of occurrence of breakage due to aging degradation.

To prevent these problems, it is necessary to specify a dimensional relationship between these constituents so that the tightening of the tightening bolt 15 will produce no excessive pressing force. That is, the effective length (L4−L5), defined by the dimension L4 for the length over no-threaded portion of the tightening bolt 15 and the thickness L5 of a washer 15A, and the dimension L2 for the thickness of the thin section 11A of the molded insulator 11 should satisfy the relationship (L4−L5)≦L2 (or L4≦L2 where the washer 15A is not used).

In tightening the tightening bolt 15 for securing, the dimensional relationship between the effective length (L4−L5) of the tightening bolt 15 and the thickness L2 of the molded insulator 11 should satisfy (L4−L5)=L2. The molded insulator 11 and the ring-shaped metal fitting 14 are not always required to be in a complete close contact; existence of a minute gap therebetween is admissible from a practical viewpoint of performance. Regarding insulation performance, no low-insulation problem will occur since the tightening bolt 15 and the ring-shaped metal fitting 14 are fully secured and conductive and the tightening bolt 15 is electrically connected.

The gas-tightness of the gas-section between the metal containers 1 and 2 can be assured and maintained by controlling the thickness of the molded insulator 11 and the thickness of the ring-shaped metal fitting 14, because the flanges 1A and 2A and the molded insulator 11 are hermetically secured helped by the O-ring 13. For example, the deformation of a JIS-specified O-ring (P300) for high-pressure hermetic sealing is 1.3 mm to 1.7 mm. This means that when the difference between the thickness L1 of the molded insulator 11 and the thickness L3 of the ring-shaped metal fitting 14 is controlled within a tolerance of 0<(L3−L1)≦0.2 mm taking the state of contact being in a both-sides contact into consideration, the gas-tightness can be properly maintained as the amount of deformation of the O-ring 13 therein will be proper.

The thickness L1 of the molded insulator 11 and the thickness L3 of the free end of the ring-shaped metal fitting 14 that is arranged on the thin section 11A covering the end face of the molded insulator 11 are determined to have almost equal dimensional relationship the one stated above. In this configuration, the insulating spacer 10, in which the ring-shaped metal fitting 14 is secured on the thin section 11A of the molded insulator 11 as illustrated in FIG. 2, is interposed between the flanges 1A and 2A and the through bolt 5 is inserted to integrally secure them by tightening the nut 6; thus the ring-shaped metal fitting 14 and the flanges 1A and 2A of the metal containers 1 and 2 are coupled in a fully close contact.

Accordingly, a current carrying path is formed between the ring-shaped metal fitting 14 and the flange 1A and 2A of the metal containers 1 and 2 through a very small contact resistance of 1 mQ or less for example in an electrical point of view. Thus, when a current of several thousand amperes of commercial rate of power flows through the live conductors 3 and 4 while usual operation of a gas-insulated equipment, this configuration enables such a circulating current as is nearly equal to the current flowing through the live conductors 3 and 4 to flow through the metal containers 1 and 2 electrically connected by the ring-shaped metal fitting 14 so that the flux that such commercial rate current generates will be cancelled thereby.

Therefore, a simple modification in the construction of the insulating spacer 10 and the proper controlling of the thickness L1 of the molded insulator 11 and the thickness L3 of the ring-shaped metal fitting 14 as illustrated in FIG. 3 permits maintaining the gas-tightness of the gas-sections of the metal containers 1 and 2 establishing the current carrying path of the circulating current on securing the insulating spacer 10 and the economical manufacturing of the insulating spacer 10 with high reliability yet with a simple configuration.

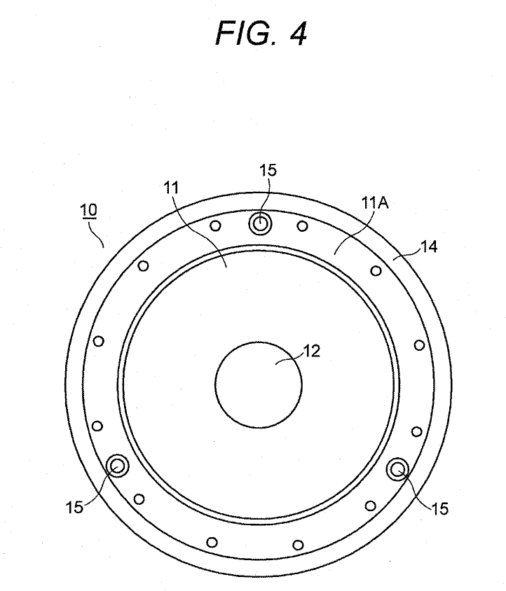

As FIG. 4 illustrates, the molded insulator 11 and the ring-shaped metal fitting 14 having cross-sectional L-shape are integrally and indispensably tightened by a plurality of tightening bolts 15 located at specified regular intervals (in FIG. 4, three bolts are arranged on the flat portion of the inner side of the ring-shaped metal fitting at approximately every 120 degrees) forming the insulating spacer 10.

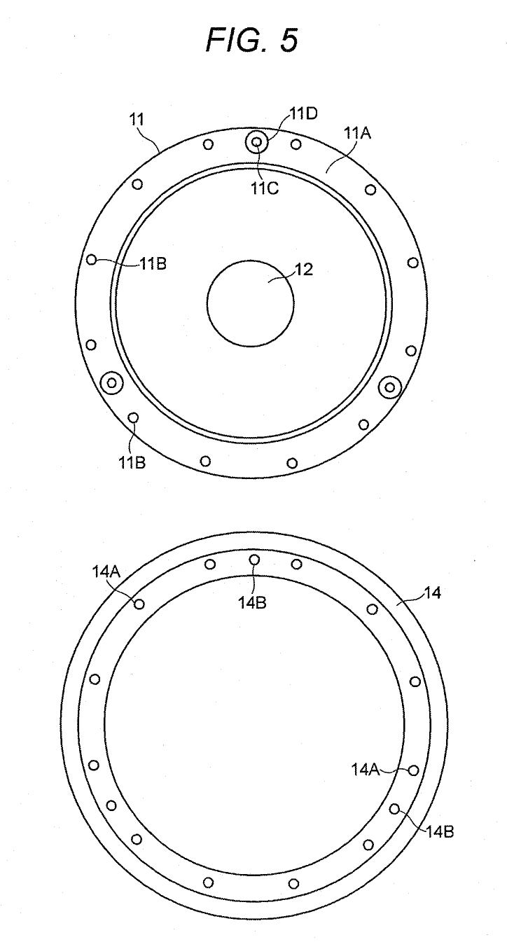

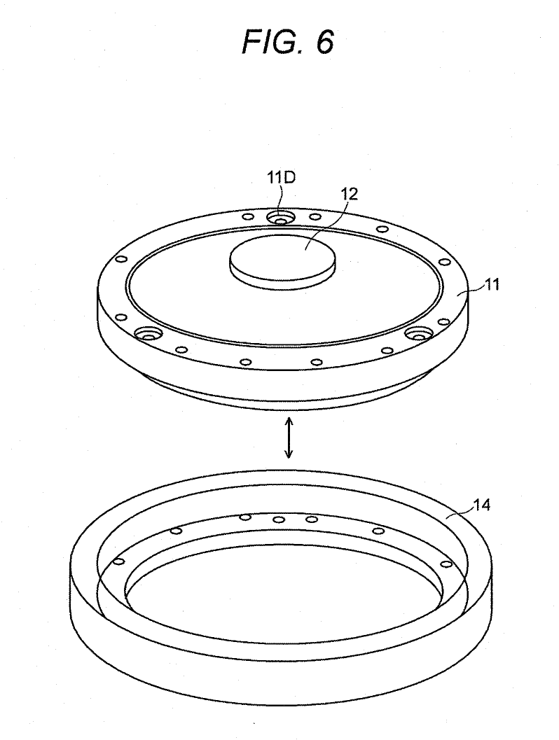

In manufacturing the insulating spacer 10, it will provide an eased fabrication to prepare the molded insulator 11 and the ring-shaped metal fitting 14 separately as illustrated in FIG. 5 and to fit them as indicated in FIG. 6 and then to integrally secure by a plurality of tightening bolts 15 as illustrated in FIG. 4.

As FIG. 5 illustrates, the ring-shaped metal fitting 14 having cross-sectional L-shape has a bolt hole 14A for passing the through bolt 5 and a bolt hole 14B for the tightening bolt 15 on the flat portion of the inner side thereof adjacent to the thin section 11A of the molded insulator 11 at a predetermined spacing. In a similar manner, a bolt hole 11B for through bolt 5 and a bolt hole 11C for tightening bolt 15 are provided on the ring-shaped metal fitting 14. The bolt hole 11C has an accommodation recess 11D to accommodate the head of the tightening bolt 15 within the dimension of the molded insulator 11.

The ring-shaped metal fitting 14 having cross-sectional L-shape in the present invention has a one-piece-one-body construction; thickness tolerance control is not tight. Therefore, the ring-shaped metal fitting 14 is not required to satisfy an excessively tight working accuracy and consequently manufacturing fault rate thereof can be reduced with economical production. Thus, a low cost supply of an insulating spacer becomes practicable.

In consideration of avoiding unexpected impact against the insulating spacer 10 that may occur in installation thereof, use of a soft cushioning material such as Teflon (a registered trade mark) or rubber for the washer 15A on the tightening bolt 15 will increase the safety against the spacer breakage. Further, it is practicable to interpose such cushioning material between the molded insulator 11 and the ring-shaped metal fitting 14. In this arrangement, tightening the tightening bolt 15 will reduce the thickness of the cushioning material; therefore, considering an actual thickness L5A reduced by the tightening, the dimensional relationship among these constituents should be regulated so that (L4−L5A)≦L2≦L4 will be satisfied.

The following explains an example, in which a gas-insulated electrical equipment is fabricated having the insulating spacer 10 installed between the flanges 1A and 2A of the metal containers 1 and 2. First, the insulating spacer 10, on which the ring-shaped metal fitting 14 and the molded insulator 11 are integrally affixed by the tightening bolt 5, is interposed between the flanges 1A and 2A, as illustrated in FIG. 1. And then, a plurality of through bolts 5 are passed to tighten by the nuts 6 provided on the both ends of the through bolts 5. With this manner of fabrication, such a construction as satisfies insulation performance and gas-tightness requirement by the insulating gas is obtained.

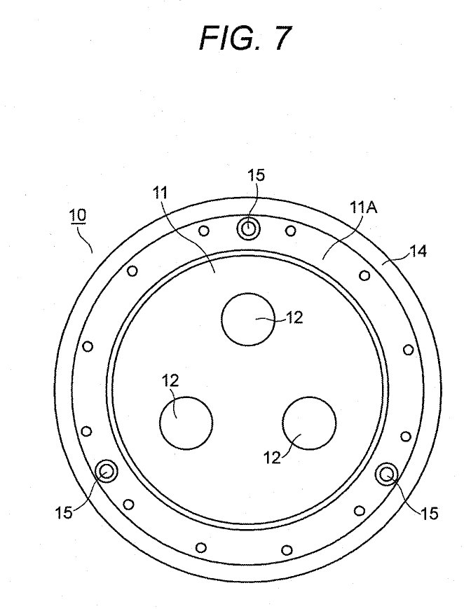

The above has described the insulating spacer 10 applied to a single-phase type spacer as an explanatory example. However, the insulating spacer 10 is easily applicable to a three-phase type spacer as illustrated in FIG. 7. The three-phase type insulating spacer 10 differs from the single-phase type merely in that three central conductors 12 are embedded in the molded insulator 11; other features are same as those in the single-phase type achieving same effect as the single-phase type offers.

### Embodiment 2

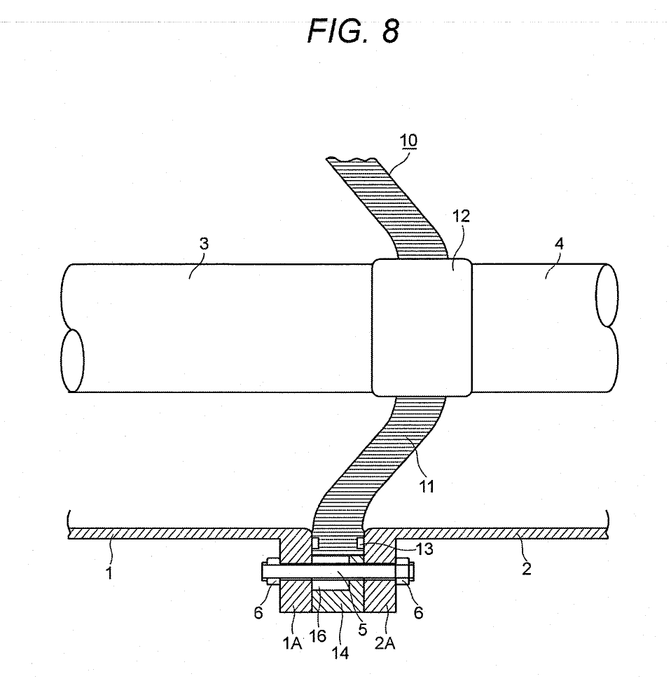

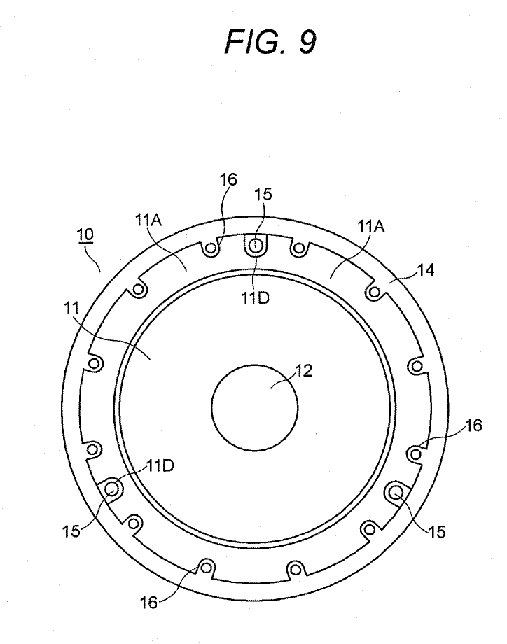

FIG. 8 and FIG. 9 illustrate another example of the insulating spacer 10 to which the present invention is applied. The insulating spacer 10 in this embodiment has a U-shaped notch 16 on the thin section 11A of the molded insulator 11 instead of a plurality of bolt holes for passing a plurality of through bolts 5.

When the bolt holes are to be provided on the thin section 11A of the molded insulator 11, the vicinity of the hole should be made thicker than the other portion for sufficiently increased mechanical strength; otherwise, should impact be given during fabrication, the thin section 11A will possibly break. In contrast, forming the U-shaped notch 16 on the molded isolator 11 eliminates a concern about breakage on the thin section with an increased reliability and a reduced overall diameter of the molded isolator 11. Thus, the insulating spacer 10 can be more economically manufactured.

Further, forming the space provided on the molded insulator 11 for accommodating the head of the tightening bolt 15 into the U-shaped accommodation recess 11D instead of a counter boring can diminish the reduction of the mechanical strength of the thin section 11A of the molded insulator 11, similarly to the case stated above.

When the insulating spacer 10 is a disc type, no problem will occur in the placing orientation because its two sides are mutually symmetrical. When it is a conic type spacer however, the spacer must provide certain degree of freedom in the placing orientation requirement because the conic type has a convex face and a concave face. To increase the freedom in the placing orientation of the insulating spacer 10, it is a feasible configuration to provide the bolt holes for tightening bolt 15 alternately on the faces of the insulating spacer; with this configuration, one type of the molded insulator 11 can accommodate to either side of the installation face.

### INDUSTRIAL APPLICABILITY

The insulating spacer for gas-insulated electrical equipment by the present invention is applicable to gas-insulated switchgears and gas-insulated bus conductors that have gas-filled configuration; therefore, the invented spacer will increase the reliability of gas-insulated electrical equipment more than ever.

1. An insulating spacer for gas-insulated electrical equipment, comprising:
a molded insulator;
a central conductor being embedded in the molded insulator; and
a metal material being arranged at the peripheral dimension of the molded insulator, the metal material with the molded insulator being placed between flanges of metal containers, the flanges being coupled by a plurality of through bolts,
wherein the peripheral dimension of the molded insulator is smaller than the dimensions of the flanges,
the molded insulator has a thin section, one lateral side of the thin section being molded into a thin ring shape,
a ring-shaped metal fitting of a cross-sectional L-shape is fitted onto the thin section, the ring-shaped metal fitting defining the dimension between the flanges and forming a current carrying path between the metal containers, and
the ring-shaped metal fitting and the thin section are secured by a plurality of tightening bolts.

2. The insulating spacer for gas-insulated electrical equipment according to claim 1, wherein the thin section has a plurality of U-shaped notches passing the through bolts therethrough.

3. The insulating spacer for gas-insulated electrical equipment according to claim 1, wherein the tightening bolts are arranged on the flat portion of the inner side of the ring-shaped metal fitting at approximately regular intervals.
